(19) United States
(12) Patent Application Publication
(10) Pub. No.: US 2009/0230337 A1
(43) Pub. Date: Sep. 17, 2009

(54) HYDRAULIC CONTROL VALVE

(75) Inventors: Jens Hoppe, Erlangen (DE); Stefan Konias, Nurnberg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/307,943

(22) PCT Filed: Jun. 29, 2007
(86) PCT No.: PCT/EP2007/056568

§ 371 Date: Apr. 10, 2009

(30) Foreign Application Priority Data
Jul. 8, 2006 (DE) 10 2006 031 595.2

(51) Int. Cl. F16K 31/00

(52) U.S. Cl. 251/62

(57) ABSTRACT

A hydraulic control valve (1) for controlling the flow of a pressure medium, having at least one drain port (T1, T2) communicating with a tank, at least one inflow port (P) communicating with a pressure medium source, and at least two supply ports (V1, V2, V3) communicating with at least one hydraulic consumer.

### BACKGROUND

The invention relates to a hydraulic control valve for controlling pressure medium flows.

In modern internal combustion engines, hydraulic control valves, in particular, proportional valves in a directional control slide valve construction are used for controlling a plurality of hydraulic loads. The control valve is made from an essentially hollow cylindrical valve housing and an axial displaceable control piston arranged therein. Here, pressure medium is fed to the control valve via at least one inflow port. Furthermore, the control valve has available one or more supply ports that are connected hydraulically to the load. In addition, at least one outflow port is provided by which pressure medium can be discharged from the control valve into a tank. As a function of the position of the control piston relative to the valve housing, pressure medium is supplied to one or more supply ports or discharged from these ports into the tank.

A consumer controlled by a control valve is, for example, a device for variable adjustment of the control times of gas-exchange valves of an internal combustion engine (camshaft adjuster). Camshaft adjusters are used to be able to variably construct the phase relation between the crankshaft and camshaft of an internal combustion engine in a defined angular range between a maximum advanced position and a maximum retarded position. For this purpose, the device is integrated into a drive train by which torque is transmitted from the crankshaft to the camshaft. This drive train can be realized, for example, as a belt, chain, or gear drive.

Such devices comprise at least two rotors that can rotate in opposite directions, wherein one rotor is in driven connection with the crankshaft and the other rotor is locked in rotation with the camshaft. The device comprises at least one pressure space that is divided by a movable element into two pressure chambers acting against each other. The moving element is in active connection with at least one of the rotors. By supplying pressure medium to or discharging pressure medium from the pressure chambers, the moving element is shifted within the pressure space, whereby a desired rotation of the rotors relative to each other and thus the camshaft relative to the crankshaft is realized.

The inflow of pressure medium to or the outflow of pressure medium from the pressure chambers is controlled by a hydraulic control valve. Here, two supply ports (work ports) of which each communicates with a pressure chamber of each pressure space are formed on the control valve.

The control valve is controlled by a regulator that determines the actual and desired positions of the camshaft of the internal combustion engine with the help of sensors and compares these positions with each other. Once a difference between both positions is determined, a signal is transmitted to the regulator that adjusts the position of the control piston relative to the valve housing of the control valve based on the signal and in this way regulates the pressure medium flows to the pressure chambers.

In order to guarantee the function of the device, the pressure in the pressure medium circuit of the internal combustion engine must exceed a certain value. Because the pressure medium is usually provided by the oil pump of the internal combustion engine and the provided pressure thus increases in sync with the rotational speed of the internal combustion engine, below a certain rotational speed the oil pressure is still too low, in order to change or hold the phase position of the rotors in a desired manner. This can be the case, for example, during the startup phase of the internal combustion engine or during the idling phase.

During these phases the device would carry out uncontrolled vibrations, which leads to increased noise emissions, increased wear, non-smooth running, and increased raw emissions of the internal combustion engine. To prevent this, mechanical locking devices can be provided that couple the two rotors to each other locked in rotation during the critical operating phases of the internal combustion engine, wherein this coupling can be canceled by applying pressure medium to the locking device. Here it has emerged to be advantageous to be able to influence the locking state of the device and thus the pressure medium supply to or the pressure medium discharge from the locking device, independent of the pressure relationships in the pressure chambers.

This is realized by a control valve that has, in addition to the two work connections that are connected to the pressure chambers, another supply port (control port) that communicates with the locking device.

Such a device and such a control valve are known, for example, from US 2003/0121486 A1. In this embodiment, the device has a rotary piston type construction, wherein an outer rotor is supported so that it can rotate on an inner rotor constructed as an impeller wheel. In addition, two rotational angle limiting devices are provided, wherein a first rotational angle limiting device in the locked state allows an adjustment of the inner rotor relative to the outer rotor in an interval between a maximum retarded position and a defined middle position (locking position). The second rotational angle limiting device allows, in the locked state, a rotation of the inner rotor to the outer rotor in an interval between the middle position and the maximum advanced position. If both rotational angle limiting devices are located in the locked state, then the phase position of the inner rotor to the outer rotor is limited to the locking position.

Each of the rotational angle limiting devices is made from a spring-loaded locking pin that is arranged in a receptacle of the outer rotor. Each locking pin is loaded with a force via a spring in the direction of the inner rotor. A locking groove that is opposite the locking pins in certain operating positions of the devices is formed on the inner rotor. In these operating positions, the pins can engage in the locking groove. In this way, the appropriate rotational angle limiting device transitions from an unlocked into a locked state.

Each of the rotational angle limiting devices can be changed from the locked state into the unlocked state by pressure medium loading of the locking groove. In this case, the pressure medium forces the locking pins back into their receptacle, by which the mechanical coupling of the inner rotor to the outer rotor is canceled.

The pressure medium loading of the pressure chambers and the locking grooves is realized by a control valve, wherein on the control valve, among other things, two work ports that communicate with the pressure chambers and one control port that communicates with the locking groove are formed. The control valve has two supply ports. One of the supply ports can be connected exclusively to the control port, while pressure medium can reach exclusively to the work ports by the other supply port. In this embodiment, the high installation space requirements of the control valve due to the plurality of ports are disadvantageous. The embodiment corresponds to two control valves arranged in series that have available a common control piston. This construction considerably limits the possibilities of control logic that can be realized in comparison to two separate control valves. More flexible or more complex control logic, primarily with respect to the control port, can be represented only with considerable consequences for the installation space requirements of the control valve.

### SUMMARY

The invention is based on the objective of providing an installation space-optimized control valve that can control the pressure medium flow to or from several supply lines via several supply ports, wherein the resulting device should have a high degree of freedom for the realization of a wide range of control logic.

In a first embodiment, a hydraulic control valve with an essentially hollow cylindrical valve housing on which at least one inflow port, at least one outflow port, and at least two supply ports are formed and with a control piston that is arranged within the valve housing and that can move axially relative to this housing, wherein first control elements are formed on an essentially cylindrical lateral surface of one of the two components within a first region extending in the axial and peripheral direction and second control elements are formed within a second region extending in the axial and peripheral direction, wherein counter control elements are formed on the other component, wherein the first control elements interact with the counter control elements such that a pressure medium flow between the first supply port and the interior of the valve housing is controlled as a function of the axial position of the components relative to each other, wherein the second control elements interact with the counter control elements such that a pressure medium flow between the second supply port and the interior of the valve housing is controlled as a function of the axial position of the components relative to each other, the objective is met according to the invention in that the first and the second region are arranged at least partially overlapping in the axial direction, that the first region extends in the peripheral direction of the control valve within a first angular region, and that the second region extends in the peripheral direction of the control valve within a second angular region, wherein the regions do not overlap in the peripheral direction.

In this embodiment, the control valve comprises at least one essentially hollow cylindrical valve housing and one control piston arranged so that it can move axially in this housing. The control piston can be shifted and held in any position between two maximum values by an actuator, for example, an electromagnetic or hydraulic actuator. In this way, the actuator can be connected to the control valve or fixed in position relative to this valve.

An inflow port and at least one outflow port are formed on the valve housing. Pressure medium is led into the hollow space within the valve housing via the inflow port. Pressure medium can flow out from the interior of the valve housing via the outflow port. In addition, several, at least two supply ports are formed that communicate via supply lines with one or several loads, for example, a device for the variable adjustment of control times of gas-exchange valves of an internal combustion engine.

The ports can be constructed, for example, as grooves that are formed on an outer lateral surface of the valve housing and communicate with the interior of the valve housing via radial openings. Alternatively, the radial openings can also be used as ports. It is also conceivable to use an axial opening of the valve housing as a port, for example, as an inflow or outflow port.

For controlling the pressure medium flows, control elements are formed on the control piston or the valve housing and counter control elements are formed on the other component. These interact such that the various supply ports cannot communicate with the interior of the valve housing or with pressure medium-guiding or pressure-less regions of the interior of the valve housing as a function of the position of the control piston relative to the valve housing. Here, for controlling the first supply port there are first control elements and for controlling the second supply port there are second control elements. Advantageously, the regions in which the first and the second control elements are formed, respectively, at least partially overlap in the axial direction, through which the axial installation-space requirements for given control logic can be minimized.

To be able to shape the pressure medium flows to the various supply ports differently for one or more axial positions of the control piston relative to the valve housing, it can be provided that the first region extends in the peripheral direction of the control valve within a first angular region and that the second region extends in the peripheral direction of the control valve within a second angular region, wherein the regions do not overlap in the peripheral direction.

In this way it is achieved that the pressure medium flows to the various supply ports do not flow offset axially relative to each other, in contrast to the state of the art, but instead parallel to each other in sectors of the control valve separated from each other in the peripheral direction. Instead of a series arrangement, there is an installation space-saving parallel arrangement.

An additional advantage of this sectorization of the pressure medium flows is that more complex control logics can also be represented, even without the need for additional installation space. This advantage is realized primarily when there are more than two supply ports. For example, in cases with three supply ports, for one of the supply ports the control elements can be formed in the entire axial region that the two other supply ports take up. The number of control elements can be increased without the need for more installation space, by which more complex switching logic can also be represented.

In one realization of the invention, it is provided to form the control elements on the valve housing. In this way it can be provided that the control elements are formed on an internal lateral surface of the valve housing.

Thus, the control piston can also be used in applications in which the control piston rotates relative to the valve housing. This is the case, for example, in applications in which the actuator is not locked in rotation with the control valve and the control valve is arranged within a central borehole of a rotating component, for example, an inner rotor of a camshaft adjuster.

In one advantageous refinement of the invention, it is provided that the first control elements interact with the counter control elements such that only one pressure medium flow between the first supply port and the interior of the valve housing is controlled as a function of the axial position of the components relative to each other. Likewise, it can be provided that the second control elements interact with the counter control elements such that only one pressure medium flow between the second supply port and the interior of the valve housing is controlled as a function of the axial position of the components relative to each other.

In another construction of a hydraulic control valve with an essentially hollow cylindrical valve housing on which at least two supply ports, at least one inflow port, and at least one outflow port are formed, the objective is met according to the invention such that at least two of the ports are arranged at least partially overlapping in the axial direction of the valve housing.

In one realization of the invention, it is provided that the supply ports are arranged at least partially overlapping in the axial direction of the valve housing.

In an advantageous refinement of the invention, it is provided that the ports overlapping in the axial direction do not overlap in the peripheral direction of the valve housing.

In one realization of the invention, it is provided that the ports overlapping in the axial direction are separated from each other hydraulically in the peripheral direction of the valve housing by blocking elements.

In this way it can be provided to form the blocking elements integrally with the valve housing. Through the partial overlapping of the ports in the axial direction, the need for axial installation space of the control valve can be reduced to a minimum. The ports, in addition to the supply ports also the inflow and/or outflow ports, can be packed more tightly in the axial direction, by which the control valve can also be used in more compact surrounding constructions or loads.

In another construction of a hydraulic control valve with an essentially hollow cylindrical valve housing and an essentially hollow cylindrical control piston that can move axially in this housing, wherein at least one inflow port (P) and at least two supply ports are formed on the valve housing, wherein pressure medium can be fed via the inflow port to the interior of the valve housing, the objective according to the invention is met in that pressure medium can be fed to the first supply port via a pressure medium line that is formed between an outer lateral surface of the control piston and an inner lateral surface of the valve housing. In this way, it can be provided to form the control piston integrally. Alternatively, the control piston can be made from several separate components.

### BRIEF DESCRIPTION OF THE DRAWINGS

Additional features of the invention emerge from the following description and from the drawings in which embodiments of the invention are shown simplified. Shown are:

FIG. 1 an embodiment according to the invention of a control valve in perspective view,

FIG. 2 a partial longitudinal section view through the control valve according to FIG. 1,

FIG. 3a a longitudinal section view through a section of the control valve according to FIG. 2,

FIG. 3b a cross-sectional view through the control valve according to FIG. 3a along the line B-B,

FIG. 3c a cross-sectional view through the control valve according to FIG. 3a along the line C-C,

FIG. 4 a cross-sectional view through a camshaft adjuster including an attached hydraulic circuit,

FIG. 5 a control logic diagram realized by the control valve according to the invention according to FIG. 2,

FIG. 6a-6g diagrams of the control valve according to FIG. 3a in its various control positions,

FIG. 7a-7e longitudinal section views through a section of another embodiment according to the invention of a control valve in its various control positions,

FIG. 8a a cross-sectional view through the control valve according to FIG. 7a along the line A-A,

FIG. 8b a cross-section view through the control valve according to FIG. 7a along the line B-B,

FIG. 8c a cross-sectional view through the control valve according to FIG. 7a along the line C-C.

### DETAILED DESCRIPTION OF THE PREFERRED EMBODIMENTS

In the following, the invention will be described with reference to a control valve 1 with three supply ports. Also conceivable would be embodiments with 2 or more than three supply ports.

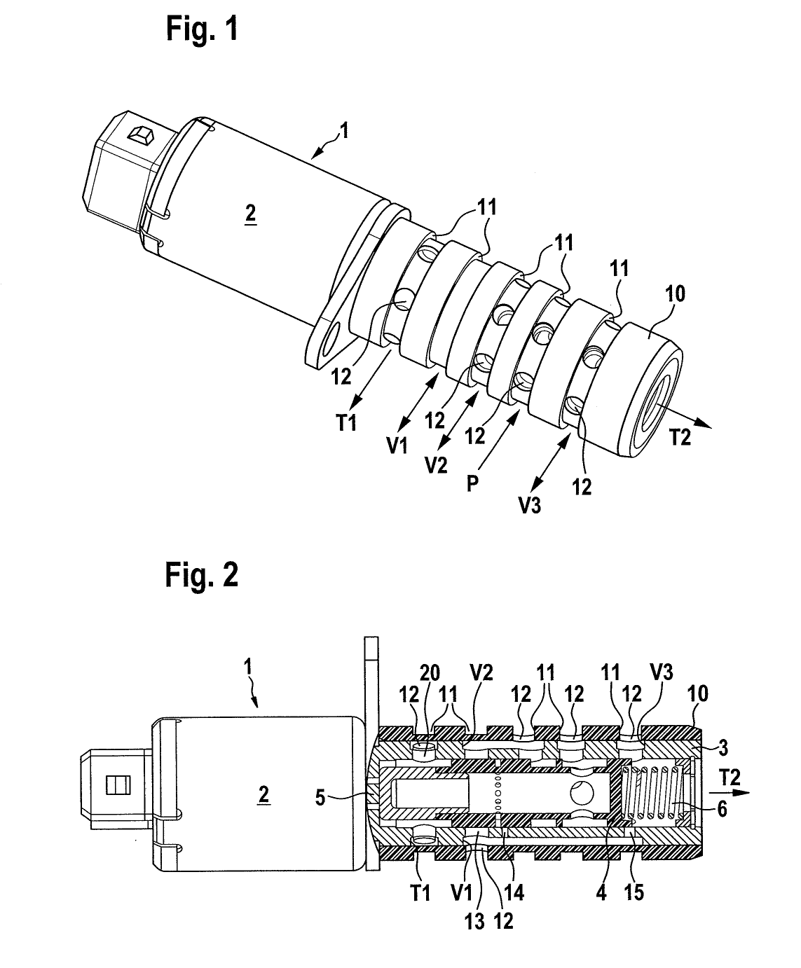

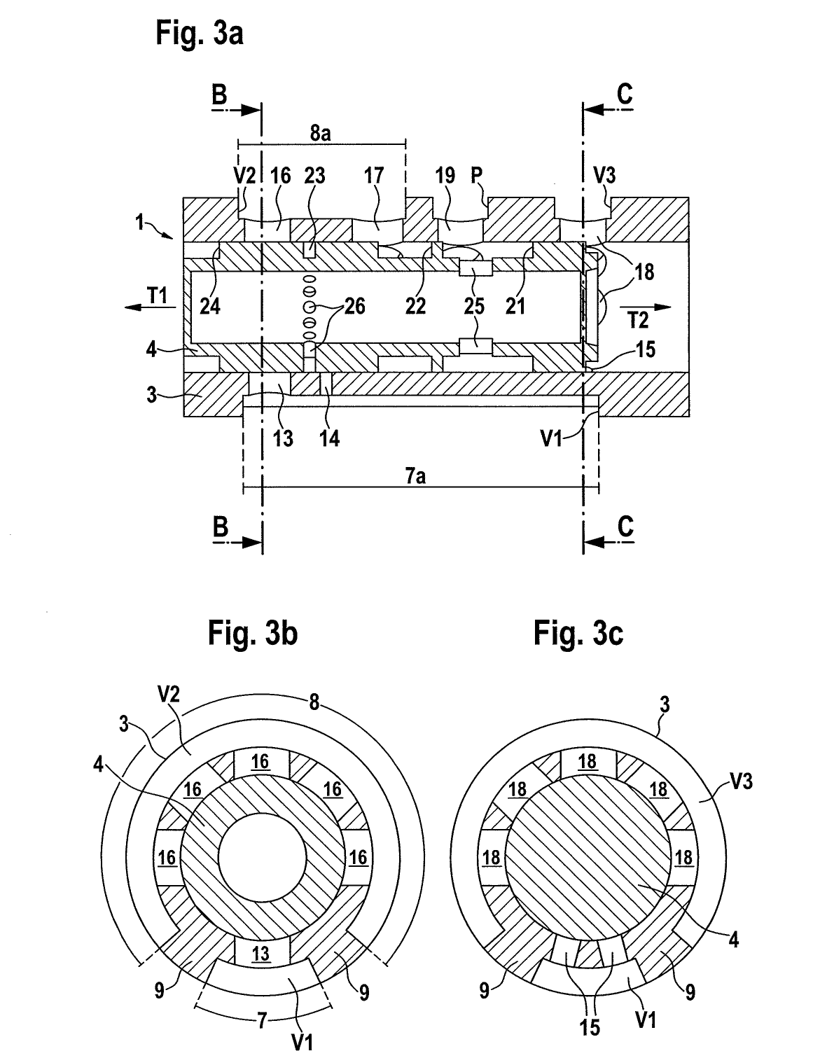

FIGS. 1 and 2 show a first embodiment of a control valve 1 according to the invention. This comprises an electromagnetic actuator 2, a valve housing 3, and a control piston 4. The essentially hollow cylindrical control piston 4 is arranged so that it can move axially within the similarly essentially hollow cylindrical valve housing 3. In this way, the outer diameter of the control piston 4 is essentially adapted to the inner diameter of the valve housing 3. Through the use of a tappet rod 5, a movement of a not-shown armature of the actuator 2 can be transferred to the control piston 4, by which the control piston can be positioned in the axial direction against the force of a spring element 6. On the valve housing 3, three supply ports V1, V2, V3, one inflow port P, one radial outflow port T1 and one axial outflow port T2 are formed. The supply ports V1, V2, V3, the inflow port P, and the radial outflow port T1 are formed as grooves extending in the peripheral direction in an outer lateral surface of the valve housing 3. The second and third supply ports V2, V3, the inflow port P, and the radial outflow port T1 are arranged offset axially relative to each other, while the first supply port V1 extends in the axial direction along the entire length of the region taken up by the other supply ports V2, V3, and the inflow port P. The axial outflow port T2 is formed as an axial opening of the valve housing 3.

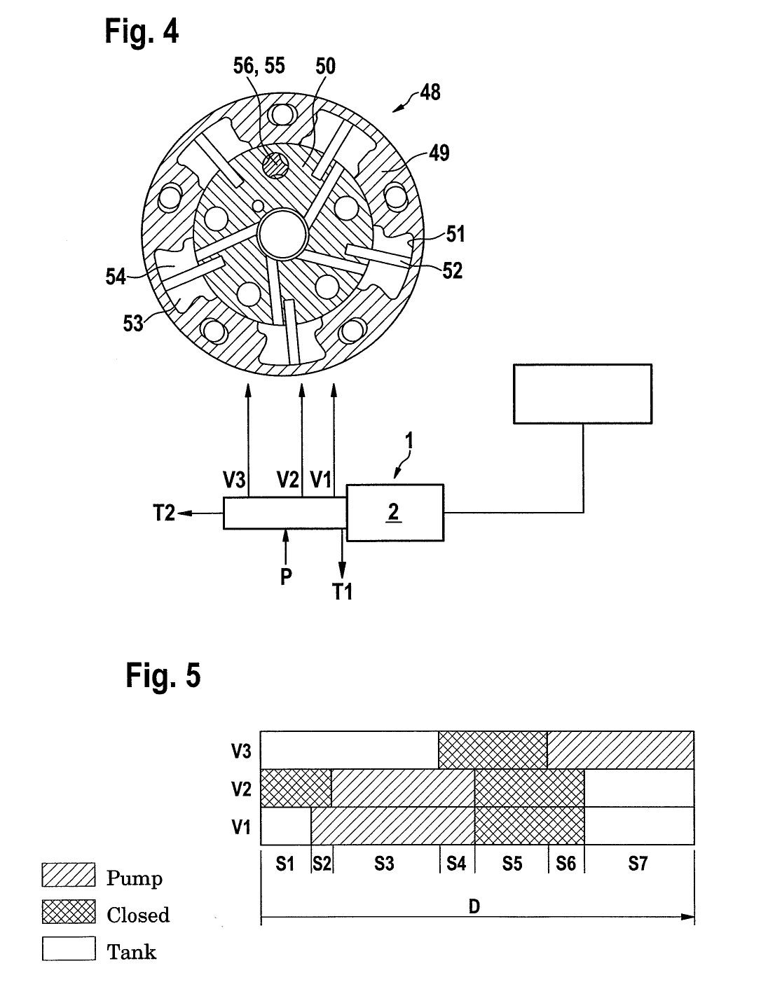

The first supply port V1 extends in the peripheral direction within a first angular range 7 and in the axial direction within a first region 7a. The second and third supply ports V2, V3 and the inflow port P extend in the peripheral direction within a second angular range 8, wherein the second supply port V2 extends in the axial direction within a second region 8a. In this way, the angular regions 7, 8 are arranged not overlapping in the peripheral direction of the control valve 1 and are separated from each other hydraulically by blocking elements 9 (FIGS. 3a to 3c). The first and the second regions 7a, 8a are advantageously arranged at least partially overlapping. In the illustrated embodiment, the second region 8a is covered completely by the first region 7a.

In addition, in the illustrated embodiment, a hollow cylindrical adapter sleeve 10 is provided that comprises the valve housing 3. In this way, the outer diameter of the valve housing 3 is adapted essentially to the inner diameter of the adapter sleeve 10. Using the adapter sleeve 10, a connection can be established between the ports P, T1, T2, V1, V2, V3, and not-shown connection lines of a surrounding construction, for example, a receptacle in a cylinder head or cylinder head cover. For this purpose, on the outer lateral surface of the adapter sleeve 10 there are five grooves 11 running in the peripheral direction and arranged offset relative to each other axially. These grooves each communicate via radial sleeve openings 12 with one of the ports P, T1, V1, V2, V3. In this way, the sleeve openings 12 of each groove 11 are formed in the peripheral direction only in the angular region 7, 8 of the corresponding port P, T1, V1, V2, V3. The advantage of this embodiment with an adapter sleeve 10 lies in that during the installation of the control valve 1, no defined installation orientation of the control valve 1 must be observed relative to the connection lines, because the pressure medium can reach each connection line via the grooves 11 in each position of the control valve 1. Also conceivable, however, are embodiments of the control valve 1 without an adapter sleeve 10 in which the outer lateral surface of the control piston 4 comes to lie directly on the valve receptacle. In the following, the invention will be explained with reference to an embodiment that is shown in FIGS. 3a to 3c.

In FIG. 3a, the part of the control valve 1 according to the invention is shown on which the inflow port P and the supply ports V1-V3 are formed. In contrast to FIG. 2, here the control piston 4 is formed in one piece. On the valve housing 3 there are eight groups of radial housing openings 13-20. The first to third housing openings 13-15 are formed exclusively in the first supply port V1 and offset relative to each other axially. The fourth and fifth housing openings 16, 17 are formed exclusively in the second supply port V2 and also offset axially relative to each other. The sixth housing openings 18 are formed exclusively in the third supply port V3. The seventh housing openings 19 are formed exclusively in the inflow port P. The eighth housing openings 20 are formed exclusively in the radial outflow port T1. Through use of the housing openings 13-20, each port P, T1, V1, V2, V3 can communicate with the interior of the valve housing 3.

On an outer lateral surface of the control piston 4 there are four annular grooves 21-24 that are spaced apart axially and that extend along the entire periphery of the control piston 4. In addition, on the control piston 4 there are two groups of radial piston openings 25, 26. The first piston openings 25 are formed in the groove base of the first annular groove 21 and the second piston openings 26 are formed in the groove base of the third annular groove 23. Through use of the piston openings 25, 26, each annular groove 21, 23 communicates with the interior of the control piston 4.

Pressure medium can be fed to the interior of the valve housing 3 via the inflow port P. Pressure medium flows can be established within the control valve 1 between various ports P, T1, T2, V1, V2, V3 by control elements and counter control elements.

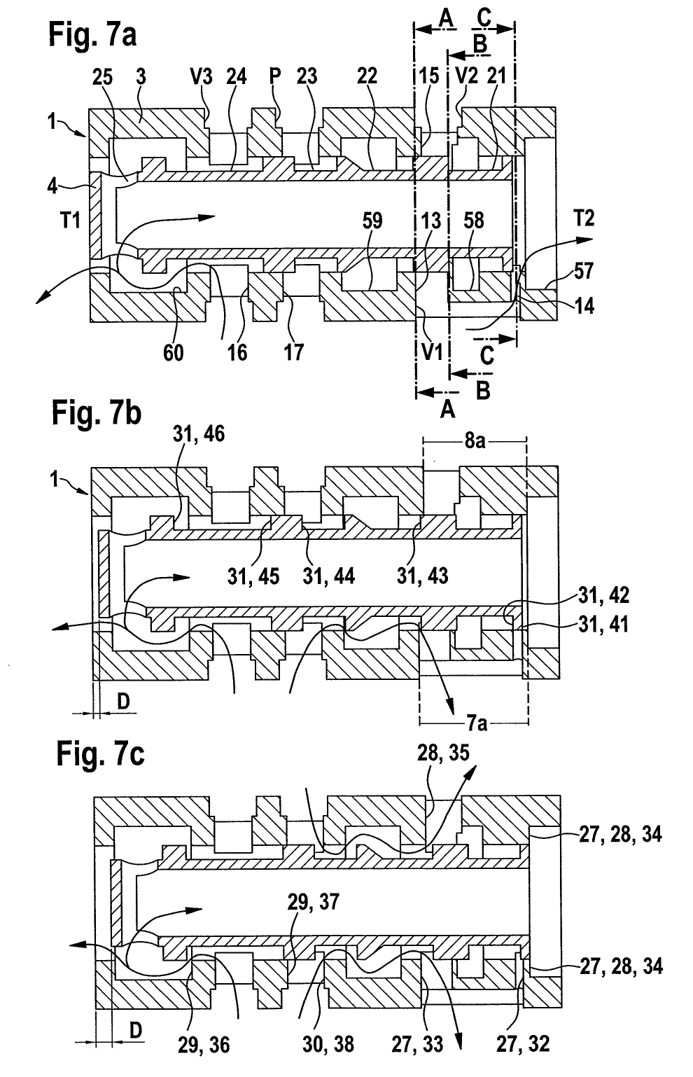

For this purpose, first to fourth control elements 27-30 (FIG. 6a) are formed on an inner lateral surface of the valve housing 3 and counter control elements 31 (FIG. 6b) are formed on an outer lateral surface of the control piston 4.

The first control elements 27 comprise four control edges 32-35, wherein the first and the second control edges 32, 33 are defined by the regions of the boundary walls of the first and third housing openings 13, 15 spaced farthest apart from each other in the axial direction.

The third and fourth control edges 34, 35 are defined by the regions of the boundary wall of the second housing opening 14 spaced farthest apart from each other in the axial direction.

The second control elements 28 comprise a fifth and a sixth control edge 36, 37, wherein these are defined by the regions of the boundary walls of the fourth and fifth housing openings 16, 17 spaced farthest apart from each other in the axial direction.

The third control elements 29 comprise a seventh and an eighth control edge 38, 39, wherein these are defined by the regions of the boundary wall of the sixth housing opening 18 spaced farthest apart from each other in the axial direction.

The fourth control elements 30 comprise a ninth control edge 40, wherein this is defined by the region of the boundary wall of the seventh housing opening 19 lying closest to the fifth housing opening 17 in the axial direction.

The counter control elements 31 comprise seventh counter control edges 41-47, wherein the first counter control edge 41 is defined by the axial boundary wall of the fourth annular groove 24, the second counter control edge 42 is defined by the spring element-side end of the control piston 4, the third and fourth counter control edges 43, 44 are defined by the axial boundary walls of the third annular groove 23, the fifth and the sixth counter control edges 45, 46 are defined by the axial boundary walls of the second annular groove 22, and the seventh counter control edge 47 is defined by the axial boundary wall of the first annular groove 21 facing away from the second annular groove 22.

The first control elements 27 are formed exclusively in the first angular region 7. The second to fourth control elements 28-30 are formed exclusively in the second angular region 8. The counter control elements 31 extend along the entire periphery of the control piston 4.

In this embodiment, the control elements 27-30 are formed on an inner lateral surface of the valve housing 3 and the counter control elements 31 are formed on the outer lateral surface of the control piston 4. Also conceivable, however, are alternative solutions with an exactly opposite configuration.

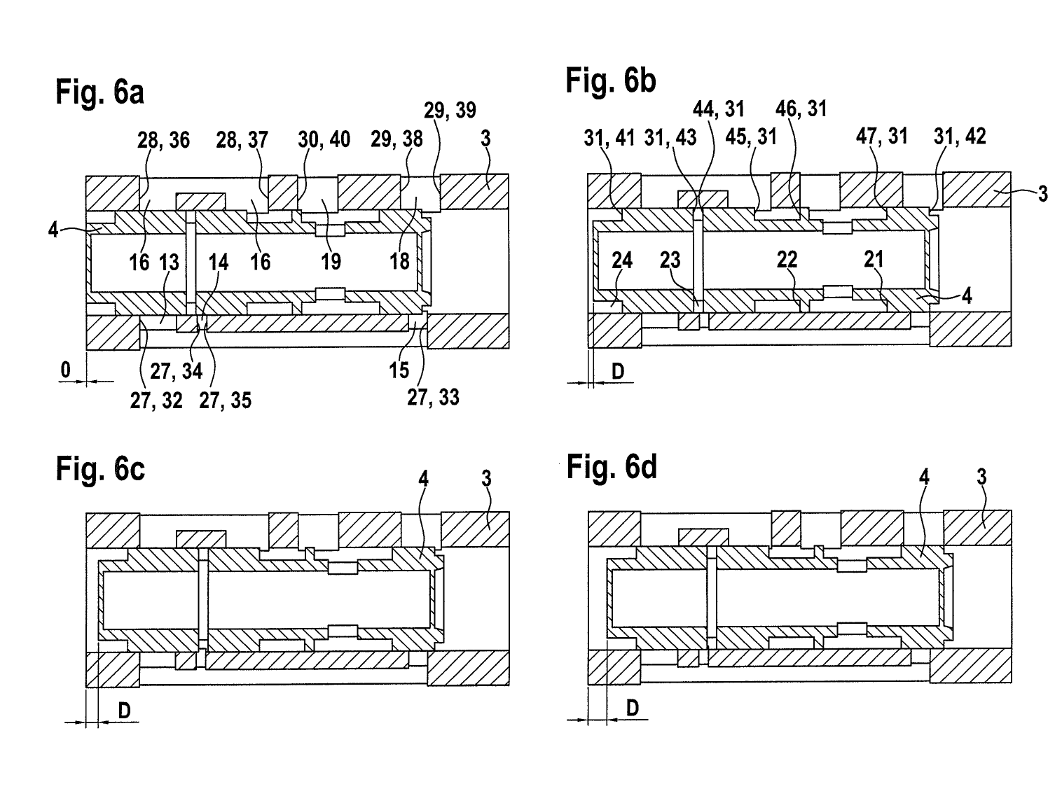

With reference to the example of a camshaft adjuster 48 shown in FIG. 4, in the following the function of the control valve 1 will be explained.

The camshaft adjuster 48 has an outer rotor 49, an inner rotor 50, and two not-shown side covers. The outer rotor 49 is in drive connection with a not-shown crankshaft, for example, by a traction mechanism drive. The inner rotor 50 is constructed in the form of an impeller wheel and is locked in rotation with a similarly not-shown camshaft. Starting from an outer peripheral wall of the outer rotor 49, several projections extend radially inward, by which the outer rotor 49 is supported on the inner rotor so that it can rotate relative to the inner rotor 50. Each of the side covers is arranged on one of the axial side surfaces of the outer rotor 49 and fixed on the rotor locked in rotation. Within the camshaft adjuster 48, there is a pressure space 51 between every two projections adjacent in the peripheral direction. This pressure space is bounded in the peripheral direction by opposing, essentially radially extending boundary walls of adjacent projections, in the axial direction by the side covers, radially inward by the inner rotor 50, and radially outward by the outer rotor 49. A vane 52 of the inner rotor 50 projects into each of the pressure spaces 51. Each vane 52 divides each pressure space 51 into two oppositely acting pressure chambers 53, 54.

By pressurizing one group of pressure chambers 53, 54 and depressurizing the other group, the phase position of the outer rotor 49 relative to the inner rotor 50 can be varied. By pressurizing both groups of pressure chambers 53, 54, the phase position of the two rotors 49, 50 can be held constant relative to each other. Alternatively, it can be provided to pressurize none of the pressure chambers 53, 54 with pressure medium during phases of constant phase position.

In addition, a locking mechanism 55 is provided with which a mechanical connection between the two rotors 49, 50 can be established. The locking mechanism 55 comprises an axially displaceable locking pin 56 that is arranged in a receptacle of the inner rotor 50. The locking pin 56 is loaded by means of a not-shown spring with a force in the direction of one of the side covers in which a not-shown locking connecting rod is formed. If the inner rotor 50 is located in a defined phase position (locking position) relative to the outer rotor 49, then the locking pin 56 can engage in the connecting rod and thus a mechanical, rotationally locked connection between the two rotors 49, 50 can be established.

To change the locking mechanism 55 from the unlocked into the locked state, it is provided that the connecting rod is pressurized with pressure medium. Therefore, the locking pin 56 is forced back against the force of the spring into the receptacle and thus the mechanical lock is cancelled.

For feeding pressure medium to the pressure chambers or discharging pressure medium from the pressure chambers 53, 54 and the connecting rod, the control valve 1 is provided. The first supply port V1 communicates with the connecting rod of the locking mechanism 55. The second supply port V2 communicates with the first pressure chambers 53. The third supply port V3 communicates with the second pressure chambers 54. The inflow port P communicates with a not-shown pressure medium source and the outflow ports T1, T2 with a similarly not-shown tank.

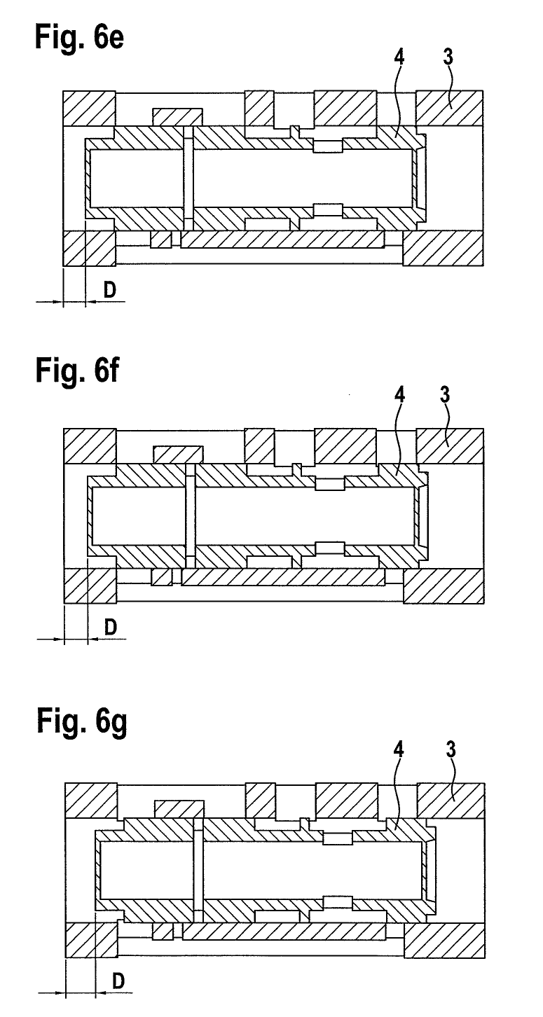

For the operation of the camshaft adjuster 48, the control logic shown in FIG. 5 has proven advantageous. As a function of the excitation of the actuator 2 or a displacement path D of the control piston 4 relative to the valve housing 3, in this case the control valve 1 runs though seven control positions S1-S7. In a first control position S1, the first and the third supply port V1, V3 are connected to one of the outflow ports T1, T2, while the second supply port V2 is connected neither to an outflow port T1, T2 nor to the inflow port P. When transitioning into the second control position S2, the first supply port V1 is separated from the outflow ports T1, T2 and connected to the inflow port P that also communicates with the second supply port V2 when transitioning to the third control position S3. When transitioning into the fourth control position S4, the third supply port V3 is separated both from the outflow ports T1, T2 and also from the inflow port P, while in the fifth control position S5, none of the supply ports V1-V3 communicates with the outflow ports T1, T2 or the inflow port P. When transitioning to the sixth control position S6, the third supply port V3 is connected to the inflow port P. When transitioning into the seventh control position S7, the first and the second supply port V1, V2 are connected to one of the outflow ports T1, T2.

The different control positions S1-S7 of the control valve 1 are shown in FIGS. 6a-6g. In contrast to the embodiment shown in FIG. 3a, the inflow port P and the third supply port V3 are each realized as housing openings 18, 19. Furthermore, the first and the second supply ports V1, V2 are formed as axially extending grooves. The second piston openings 26 are here indicated by two perpendicular lines. The axial displacement path of the control piston 4 relative to the valve housing 3 is designated with D, wherein the configuration shown in FIG. 6a corresponds to a displacement path D=0. Here, the control piston 4 assumes one of the maximum end positions.

Pressure medium can be fed via the inflow port P to the control valve 1. This pressure medium is led via the seventh housing openings 19 into the interior of the valve housing 3. Thus, in every control position S1-S7, pressure medium is led into the first annular groove 21, via the first piston opening 25 into the interior of the control piston 4, and via the second piston openings 26 into the third annular groove 23. In the third to seventh control piston S3-S7, pressure medium is also led into the second annular groove 22.

In FIG. 6a, control valve 1 is shown in the first control position S1. In this control position S1, the first, the second, the fourth housing openings 13, 14, 16 and the connection between the seventh housing opening 19 and the second annular groove 22 are blocked by the control piston 4, while the second or the eighth control edge 33, 39 in connection with the second counter control edge 42 releases a connection between the first or the third supply port V1, V3 and the axial outflow port T2. Thus, pressure medium is led from the first and the third supply port V1, V3 to the axial outflow port T2 and furthermore into a not-shown tank. Simultaneously, the second supply port V2 communicates neither with one of the outflow ports T1, T2 nor with the inflow port P.

In FIG. 6b, the control valve 1 is shown in the second control position S2. In this control position S2, the first, the third, the fourth housing openings 13, 15, 16 and the connection between the seventh housing opening 19 and the second annular groove 22 are blocked by the control piston 4, while the eighth control edge 39 in connection with the second counter control edge 42 releases a connection between the third supply port V3 and the axial outflow port T2. Simultaneously, the third control edge 34 in connection with the fourth counter control edge 44 enables a connection between the second housing opening 14 and the third annular groove 23. Thus, pressure medium is led from the third supply port V3 to the axial outflow port T2 and from the interior of the control piston 4 to the first supply port V1. Simultaneously, the second supply port V2 communicates neither with one of the outflow ports T1, T2 nor with the inflow port P.

When transitioning to the third control piston S3 shown in FIG. 6c of the control valve 1, the ninth control edge 40 in connection with the sixth counter control edge 46 releases a connection between the inflow port P and the second annular groove 22, by which pressure medium between the sixth control edge 37 and the fifth counter control edge 45 is led to the second supply port V2.

When transitioning to the fourth control position S4 of the control valve 1 shown in FIG. 6d, the sixth housing opening 18 is blocked by the control piston 4, by which the third supply port V3 communicates neither with one of the outflow ports T1, T2 nor with the inflow port P.

Another displacement D of the control piston 4 causes the transition to the fifth control position S5 of the control valve 1 shown in FIG. 6e. Here, the second and the fifth housing opening 14, 17 are blocked by the control piston 4. Thus, the supply ports V1, V2, V3 communicate neither with one of the outflow ports T1, T2 nor with the inflow port P.

Another displacement D of the control piston 4 causes the transition to the sixth control position S6 of the control valve 1 shown in FIG. 6f. Here, the seventh control edge 38 in connection with the seventh counter control edge 47 releases a connection between the third supply port V3 and the first annular groove 21, by which pressure medium is led from the inflow port P to the third supply port V3.

Another displacement D of the control piston 4 causes the transition to the seventh control position S7 of the control valve 1 shown in FIG. 6g. Here, the first or the fifth control edge 32, 36 in connection with the first counter control edge 41 releases a connection between the first or second supply port V1, V2 and the fourth annular groove 24, by which pressure medium is led from the first and second supply port V1, V2 to the radial outflow port T1.

In this embodiment, the pressure medium flow is led to the first supply port V1, within the control piston 4, parallel to the pressure medium flows to the other supply ports V2, V3, into the first and second annular groove 21, 22. Both the interior of the control piston 4 and also the first and second annular groove 21, 22 are used as pressure medium lines. Instead of a series arrangement of ports, a parallel arrangement can be selected, wherein one of the pressure medium lines can supply pressure medium to the first supply port V1 and the other pressure medium lines can supply pressure medium to the second and third supply ports V2, V3. Therefore, the need for installation space for the control valve 1 can be reduced significantly.

In addition, in contrast to the embodiment in the state of the art, only one inflow port P is required, by which the need for axial installation space is further reduced. Through the arrangement of the ports P, V1, V2, V3 in axially overlapping regions, there is more space for forming the control elements 27-30 having a smaller need for installation space. In this way, more complex control logic can also be realized. Because the first control elements 27 can be formed independent of and along the entire region of the second to fourth control elements 28-30, through slight modifications on the valve housing 3, a plurality of conceivable control logic can be realized.

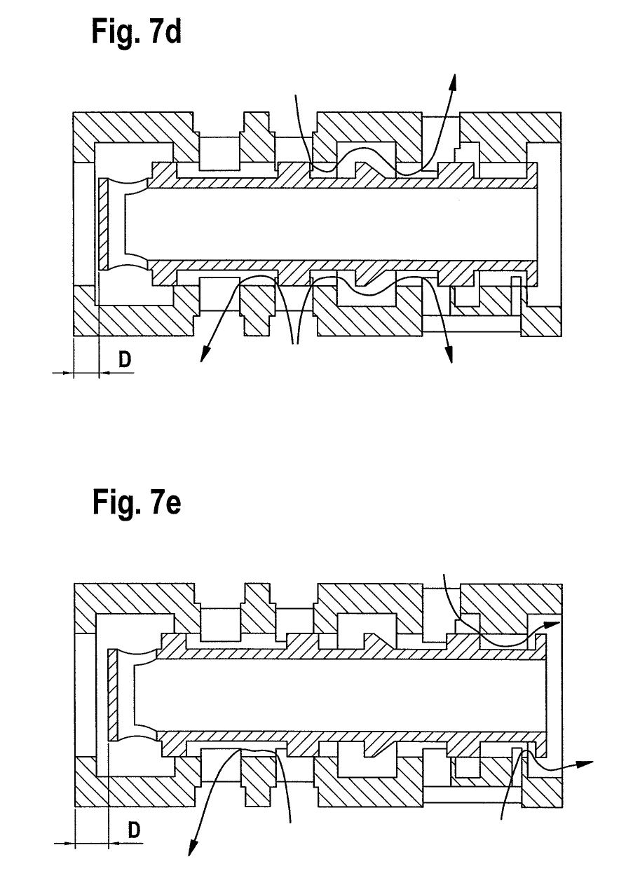

FIG. 7a shows another embodiment of a control valve 1 according to the invention. Analogous to the diagram 3a of the first embodiment, only the valve housing 3 and the control piston 4 are shown in the region of the supply ports V1-V3 and the inflow port P. The essentially hollow cylindrical control piston 4 can move axially within the similarly essentially hollow cylindrical valve housing 3. In this way, the outer diameter of the control piston 4 is essentially adapted to the inner diameter of the valve housing 3. Through the use of a not-shown tappet rod, a movement of a not-shown armature of the actuator 2 can be transferred to the control piston 4, by which this can be positioned in the axial direction against the force of a not-shown spring element. On the valve housing 3, three supply ports V1, V2, V3, one inflow port P, and one axial outflow port T2 are formed. In addition, analogous to FIG. 2, another radial outflow port T1 can be formed.

The supply ports V1, V2, V3 and the inflow port P are formed as grooves in an outer lateral surface of the valve housing 3, wherein these grooves extend in the peripheral direction. The third supply port V3 and the inflow port P are offset axially relative to each other and offset axially relative to the first and second supply ports V1, V2, while the first and the second supply ports V1, V2 are arranged overlapping in the axial direction.

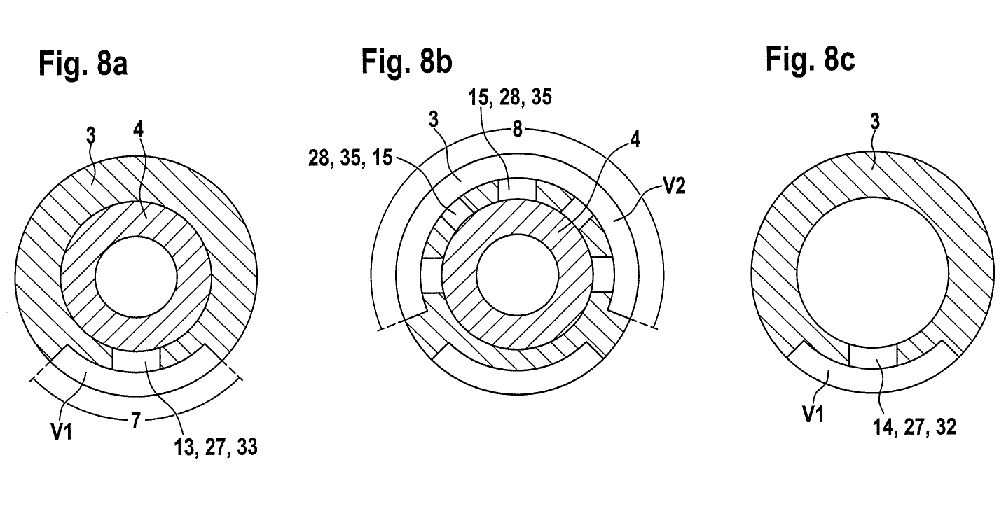

The first supply port V1 extends in the peripheral direction within a first angular region 7, while the second supply port V2 extends in the peripheral direction within a second angular region 8. In this way, the angular regions 7, 8 do not overlap in the peripheral direction of the control valve 1 (FIGS. 8a-8c). The third supply port V3 and the inflow port P extend along the entire periphery of the valve housing 3.

Just as in the first embodiment, the use of an adapter sleeve 10 is conceivable that establishes a connection between the control valve 1 and a surrounding construction.

On the valve housing 3 there are five groups of radial housing openings 13-17. The first and second housing openings 13-14 are formed exclusively in the first supply port V1 and offset axially relative to each other. The third housing openings 15 are formed exclusively in the second supply port V2. The fourth housing openings 16 are formed exclusively in the third supply port V3. The fifth housing openings 17 are formed exclusively in the inflow port P. Using the housing openings 13-17, each port P, V1, V2, V3 can communicate with the interior of the valve housing 3.

In addition, on an inner lateral surface of the valve housing 3 there are four housing grooves 57-60 offset axially relative to each other and four annular grooves 21-24 spaced apart on an outer lateral surface of the control piston 4. The annular and the housing grooves 21-24, 57-60 extend along the entire periphery of the control piston 4 or the valve housing 3, wherein the second annular groove 22 can also be formed only within the second angular region 8 or as an axial groove within the second angular region 8. In addition, on the control piston 4 there are radial piston openings 25 by which the four housing grooves 60 communicate with the interior of the control piston 4.

Pressure medium can be fed to the interior of the valve housing 3 via the inflow port P. Through the use of control elements and counter control elements, pressure medium flows can be established within the control valve 1 between various ports P, T1, T2, V1, V2, V3. For this purpose, first to fourth control elements 27-30 are formed on an inner lateral surface of the valve housing 3 and counter control elements 31 are formed on an outer lateral surface of the control piston 4.

The first control elements 27 comprise three control edges 32-34, wherein the first and the second control edge 32, 33 are defined by the regions of the boundary walls of the first and second housing openings 13, 14 spaced farthest apart from each other in the axial direction. The third control edge 34 is defined by the axial boundary wall of the first housing groove 57.

The second control elements 28 comprise the third and a fourth control edge 34, 35, wherein the fourth control edge 35 is defined by the regions of the boundary walls of the third housing openings 15 facing the inflow port P.

The third control elements 29 comprise a fifth and a sixth control edge 36, 37. The fifth control edge 36 is defined by the axial boundary wall of the fourth housing groove 60 and the sixth control edge 37 is defined by the regions of the boundary walls of the fifth housing openings 17 facing the third supply port V3.

The fourth control elements 30 comprise a seventh control edge 38, wherein this is defined by the regions of the boundary walls of the fifth housing openings 17 axially opposite the sixth control edges 37.

The counter control elements 31 comprise six counter control edges 41-46, wherein the first counter control edge 41 is defined by the spring element-side end of the control piston 4, the second counter control edge 42 is defined by the spring element-side, axial boundary wall of the first annular groove 21, the third counter control edge 43 is defined by the spring element-side, axial boundary wall of the second annular groove 22, the fourth counter control edge 44 is defined by the axial boundary wall of the third annular groove 23 facing away from the spring element 6, and the fifth and sixth counter control edges 45, 46 are defined by the axial boundary walls of the fourth annular groove 23.

The first and the second control edges 32, 33 are formed exclusively in the first angular region 7. The fourth control edge 35 is formed exclusively in the second angular region 8. The third and fifth to seventh control edges 34, 36-38 are formed along the entire inner periphery of the valve housing 3. The counter control elements 31 extend along the entire periphery of the control piston 4.

The control logic realized in this embodiment of a control valve 1 corresponds to that shown in FIG. 5 with the exception that, in the fifth control position S5, all of the supply ports V1-V3 communicate with the inflow port P.

The different control positions S1-S7 of the control valve 1 are shown in FIGS. 7a-7e. In contrast to the embodiment shown in FIG. 7a, in FIGS. 7b-7e, the second supply port V2 is realized by the third housing openings 15.

Pressure medium can be fed to the control valve 1 via the inflow port P. This pressure medium is led via the fifth housing openings 17 into the interior of the valve housing 3. In the first to fifth control position S1-S5, pressure medium is thus led into the third annular groove 23. In the second to fifth control positions S2-S5, pressure medium is also led from the third annular groove 23 via the third housing groove 59 into the second annular groove 22. In the fifth to seventh control positions S5-S7, the pressure medium supplied from the inflow port P is led into the fourth annular groove 24.

In FIG. 7a, control valve 1 is shown in the first control position S1. In this control position S1, pressure medium is led via the fifth housing opening 17 exclusively into the third annular groove 23, while a pressure medium flow into the second or fourth annular groove 22, 24 is blocked by the control piston 4. In addition, the first housing opening 13 is also blocked by the control piston 4. Thus, none of the supply ports V1-V3 communicates with the inflow port P. The first control edge 32 in connection with the first counter control edge 41 releases a connection between the second housing opening 14 and the first housing groove 57. Thus, pressure medium can flow from the first supply port V1 to the axial outflow port T2. In addition, the fifth control edge 36 in connection with the sixth counter control edge 46 releases a connection between the fourth housing opening 16 and the fourth housing groove 60. Pressure medium can thus flow from the third supply port V3 to an optional radial outflow port T1 or via the first piston openings 25 to the axial outflow port T2. Simultaneously, a connection between the second supply port V2 and the axial outflow port T2 is blocked by the control piston 4, by which this communicates with neither an outflow port T1, T2 nor the inflow port P.

When transitioning to the second control position S2 of the control valve 1 shown in FIG. 7b, the control piston 4 releases a connection between the third and the second annular groove 23, 22 via the third housing groove 59. Simultaneously, the second control edge 33 in connection with the third counter control edge 43 releases a connection between the second annular groove 22 and the first housing opening 13. In addition, the control piston 4 blocks the connection between the second housing opening 14 and the first housing groove 57. Thus, pressure medium is led from the inflow port P to the first supply port V1, wherein it is also simultaneously blocked from flowing to the axial outflow port T2. Simultaneously, the control piston 4 blocks a connection between the first supply port V1 and the second housing groove 58.

When transitioning to the third control position S3 of the control valve 1 shown in FIG. 7c, the fourth control edge 35 in connection with the third counter control edge 43 releases a connection between the third housing opening 15 and the second annular groove 22, by which pressure medium is led from the inflow port P to the second supply port V2.

Upon further displacement D of the control piston 4 into the fourth control position S4, initially the fifth control edge 36 in connection with the sixth counter control edge 46 closes the connection between the fourth housing opening 16 and the fourth housing groove 60, by which the third supply port V3 communicates neither with one of the outflow ports T1, T2 nor with the inflow port P.

Upon further displacement D of the control piston 4, the control valve 1 transitions into the fifth control position S5 shown in FIG. 7d. In this way, the sixth control edge 37 in connection with the fifth counter control edge 45 releases a connection between the fifth housing opening 17 and the fourth annular groove 24, by which pressure medium is led from the inflow port P to the third supply port V3.

Further displacement D of the control piston 4 into the sixth control position S6 has the effect that the connection between the fifth housing opening 17 and the third annular groove 23 is blocked by the seventh control edge 38 in connection with the fourth counter control edge 44. Thus, the first and the second supply port V2 are connected neither to one of the outflow ports T1, T2 nor to the inflow port P.

When transitioning to the seventh control position S7 of the control valve 1 shown in FIG. 7e, the third control edge 34 in connection with the second counter control edge 42 releases a connection between the second or third housing opening 14, 15 and the first housing groove 57. Pressure medium can be led from the first or second supply port V1, V2 via the second or third housing opening 14, 15 and the first annular groove 21 to the axial outflow port T2.

### REFERENCE SYMBOLS

1 Control valve
2 Actuator
3 Valve housing
4 Control piston
5 Tappet rod
6 Spring element
7 First angular region
7a First region
8 Second angular region
8a Second region
9 Blocking element
10 Adapter sleeve
11 Groove
12 Sleeve opening
14 First housing opening
15 Third housing opening
16 Fourth housing opening
17 Fifth housing opening
18 Sixth housing opening
19 Seventh housing opening
20 Eighth housing opening
21 First annular groove
22 Second annular groove
23 Third annular groove
24 Fourth annular groove
25 First piston opening
26 Second piston opening
27 First control element
28 Second control element
29 Third control element
30 Fourth control element
31 Counter control element
32 First control edge
33 Second control edge
34 Third control edge
35 Fourth control edge
36 Fifth control edge
37 Sixth control edge
38 Seventh control edge
39 Eighth control edge
40 Ninth control edge
41 First counter control edge
42 Second counter control edge
43 Third counter control edge
44 Fourth counter control edge
45 Fifth counter control edge
46 Sixth counter control edge
47 Seventh counter control edge
48 Camshaft adjuster
49 Outer rotor
50 Inner rotor
51 Pressure space
52 Vane
53 First pressure chamber
54 Second pressure chamber
55 Locking mechanism
56 Locking pin
57 First housing groove
58 Second housing groove
59 Third housing groove
60 Fourth housing groove
D Displacement path
P Inflow port
T1 Radial outflow port
T2 Axial outflow port
V1 First supply port
V2 Second supply port
V3 Third supply port

1. Hydraulic control valve comprising:
an essentially hollow cylindrical valve housing,
on which at least one inflow port, at least one outflow port, and at least two supply ports are formed,
and a control piston that is arranged within the valve housing and that can move axially relative to the housing,
wherein first control elements are formed on an essentially cylindrical lateral surface of one of the valve housing or the control piston within a first region extending in axial and peripheral directions and second control elements are formed within a second region extending in the axial and peripheral directions,
wherein counter control elements are formed on the other of the valve housing or the control piston,
wherein the first control elements interact with the counter control elements such that a pressure medium flow between the first supply port and an interior of the valve housing is controlled as a function of an axial position of the valve housing and the control piston relative to each other,
wherein the second control elements interact with the counter control elements such that a pressure medium flow between the second supply port and the interior of the valve housing is controlled as a function of the axial position of the valve housing and the control piston relative to each other,
the first and the second regions are arranged at least partially overlapping in the axial direction.

2. Control valve according to claim 1, wherein the first region extends in the peripheral direction of the control valve within a first angular region and the second region extends in the peripheral direction of the control valve within a second angular region, wherein the regions do not overlap in the peripheral direction.

3. Control valve according to claim 1, wherein the control elements are formed on the valve housing.

4. Control valve according to claim 1, wherein the control elements are formed on an inner lateral surface of the valve housing.

5. Control valve according to claim 1, wherein the first control elements interact with the counter control elements such that only a pressure medium flow between the first supply port and the interior of the valve housing is controlled as a function of the axial position of the valve housing and the control piston relative to each other.

6. Control valve according to claim 1, wherein the second control elements interact with the counter control elements such that only a pressure medium flow between the second supply port and the interior of the valve housing is controlled as a function of the axial position of the valve housing and the control piston relative to each other.

7. Hydraulic control valve comprising:
an essentially hollow cylindrical valve housing,
on which at least two supply ports, at least one inflow port, and at least one outflow port are formed
at least two of the ports are arranged at least partially overlapping in an axial direction of the valve housing.

8. Control valve according to claim 7, the supply ports are arranged at least partially overlapping in the axial direction of the valve housing.

9. Control valve according to claim 7, wherein the ports overlapping in the axial direction do not overlap in a peripheral direction of the valve housing.

10. Control valve according to claim 7, wherein the ports overlapping in the axial direction are separated hydraulically from each other in a peripheral direction of the valve housing by blocking elements.

11. Control valve according to claim 10, wherein the blocking elements are formed integrally with the valve housing.

12. Hydraulic control valve comprising an essentially hollow cylindrical valve housing and an essentially hollow cylindrical control piston that can move axially in the housing, at least one inflow port and at least two supply ports are formed on the valve housing, pressure medium can be fed via the inflow port to an interior of the valve housing, the pressure medium can be fed to the first supply port via an interior of the control piston and the pressure medium can be fed to the second supply port via a pressure medium line that is formed between an outer lateral surface of the control piston and an inner lateral surface of the valve housing.

13. Control valve according to claim 12, wherein the control piston is constructed in one piece.

14. Control valve according to claim 12, wherein the control piston is made from several separate components.
